(19) United States
(12) Patent Application Publication
(10) Pub. No.: US 2011/0136618 A1
(43) Pub. Date: Jun. 9, 2011

(54) POWER TRANSMISSION APPARATUS FOR A BICYCLE

(75) Inventor: Moon Jae Lee, Bucheon-si (KR)

(73) Assignee: SUNG JAE I&C CO., LTD, Seoul (KR)

(21) Appl. No.: 12/995,648

(22) PCT Filed: Oct. 14, 2009
(86) PCT No.: PCT/KR09/05889

§ 371 Date: Feb. 21, 2011

(30) Foreign Application Priority Data
Oct. 14, 2008 (KR) 10-2008-0100600

(51) Int. Cl. B62M 11/00; F16H 1/28

(52) U.S. Cl. 475/331

(57) ABSTRACT

The present invention relates to a bicycle driving apparatus, and more particularly, to a bicycle driving apparatus which enables the forward travel of the bicycle regardless of the forward rotation or reverse rotation of the pedals. The bicycle driving apparatus according to the present invention enables a bicycle to travel in the forward direction not only when a pedal rotates in the forward direction but also when the pedal rotates in the reverse direction.

### TECHNICAL FIELD

The present invention relates to a power transmission apparatus for a bicycle. More particularly, the power transmission apparatus for a bicycle of the invention can propel the bicycle forward when the pedals of the bicycle are actuated not only forward but also backward, can be installed without limitation as to place since it occupies a small space due to its simple structure, and eliminates the need to operate an additional conversion lever in order to propel the bicycle forward in the case of backward actuation.

### BACKGROUND ART

In general, a bicycle has problems in that, because it can only be propelled forward through the forward actuation of pedals, the user's legs easily become tired when he/she has pedaled for a long time, and leg muscles are irregularly developed.

Therefore, a bicycle that can be propelled forward even when the pedals are actuated backward has been required in order to prevent fatigue of the legs due to continued forward pedaling, to make it easy to ride on the bicycle for a long time, and to make the bicycle suitable for a leisure activity.

In addition, the development of the bicycle that is propelled through forward and backward actuation has encountered a problem associated with the backward propulsion of the bicycle. When the user gets off the bicycle and pushes it backward, the pedals are generally rotated backward. In the case of a bicycle that is propelled through forward and backward actuation, it is impossible to move the bicycle backward, since the backward rotation of the pedals generates force in the forward direction.

Therefore, there is continued demand in the market for a new type of bicycle that is propelled through forward and backward actuation and thus can overcome the foregoing problems.

### DISCLOSURE

### Technical Problem

The present invention has been devised in order to satisfy the foregoing demands, and an object of the invention is to provide a power transmission apparatus for a bicycle, which can propel the bicycle forward when the pedals of the bicycle are actuated not only forward but also backward, which can be attached to any type of existing bicycle since it occupies a small space due to its simple structure, and which is free from small disorders and thus does not require regular maintenance.

An object of the invention is to provide a bicycle that can use both forward actuation and backward actuation of the pedals as power in order to propel the bicycle forward.

An object of the invention is to provide a power transmission apparatus and a bicycle using the same, in which the pedals are not rotated backward when the bicycle is pushed backward.

### Technical Solution

In order to realize the foregoing objects, the power transmission apparatus for a bicycle of the invention includes a pedal shaft, which is rotated forward or backward by pedals of the bicycle fixed thereto. Two shaft rotary members are fixed to the pedal shaft, and rotate following the rotation of the pedal shaft. A rack gear-mounting member is mounted on the shaft rotary members, in which two groups of rack gears, which convert the rotation of the pedal shaft into a linear movement, are supposed to be mounted on the rack gear-mounting member. A forward rack gear is provided on one side of the rack gear-mounting member and is engaged with one of the shaft rotary members. The forward rack gear linearly moves to engage with a cover housing, thereby rotating the cover housing forward, when the pedal shaft is actuated forward, and moves backward to disengage from the cover housing when the pedal shaft is actuated backward. A backward rack gear is provided on the other side of the rack gear-mounting member and engaged with the other one of the shaft rotary members. The backward rack gear linearly moves to engage with a conversion gear group, which is engaged with the cover housing, thereby rotating the cover housing forward, when the pedal shaft is actuated backward, and moves backward to disengage from the conversion gear group when the pedal shaft is actuated forward. The cover housing is rotated by being engaged with the first rack gear and the conversion gear group, and a chain is connected to an outer circumference of the cover housing.

In the present invention, each of the shaft rotary members is a member that is fixed to a rotary shaft such that the shaft rotary member can move the rack gears forward or backward by being engaged with the rack gears when the rotary shaft is rotated. In an embodiment of the invention, it is preferred that the shaft rotary member be a shaft gear that is formed on the surface of a ring-shaped member, which is fitted around the shaft, or a shaft pin in the form of a protruding pin. If the shaft rotary member is the shaft gear, the rack gear has gear teeth, which engage with the shaft gear. If the shaft rotary member is the shaft pin, the rack gear has a pin recess, which engages with the shaft pin.

In the present invention, the rack gear-mounting member is a cylinder member that has an opening into which the shaft gear can be fitted. The forward rack gear is provided on rack gear-mounting recesses formed on one end of the rack gear-mounting member, and the backward rack gear is provided on rack gear-mounting recesses formed on the other end of the rack gear-mounting member. In an embodiment of the invention, it is preferred that the rack gear-mounting recesses include two linear recesses on one side and two linear recesses on the other side of the opening of the cylinder, such that a pair of the forward rack gears is provided on the upper portion of the rack gear-mounting member and a pair of the backward rack gears is provided on the lower portion of the rack gear-mounting member. Since one pair of the rack gears is provided on the upper portion and the other pair of the rack gears is provided on the lower portion, the rack gears can stably transmit power.

In the present invention, the rack gears have teeth formed only on one side thereof. When rotating force is applied to one side on which the teeth are formed, the rack gears transmit power through a gear, which is in contact therewith. When rotating force is applied to the other side on which no teeth are formed, the rack gears are not actuated and do not transmit power.

In an embodiment of the invention, each of the rack gears is a member having a rectangular outline, which can be fitted into the rack gear-mounting recess. On one end of the rack gear, gear teeth form a curved surface corresponding to the circumference of the rack gear-mounting member. On the other end of the rack gear, no gear teeth are formed. Gear teeth or an insert is formed on the side surface, which is in contact with the rotary shaft. In addition, the rack gear moves forward or backward inside the rack gear-mounting recess following the rotation of the shaft rotary member, such as the shaft gear or the shaft pin, since it is shorter than the rack gear-mounting recess.

In the present invention, in the case of forward rotation, the forward rack gear engages with the first gear teeth, which are formed in the inner portion of the cover housing, to rotate the cover housing forward, thereby propelling the bicycle forward. In the case of backward rotation, the backward rack gear engages with the conversion gear group, which in turn engages with the cover housing to rotate the cover housing forward, thereby propelling the bicycle forward. Therefore, the cover housing has the first female gear, which engages with the forward rack gear, and the second female gear, which engages with the conversion gear group.

In the present invention, both the forward rack gear and the backward rack gear are mounted on the rack gear-mounting member such that the teeth of the forward rack gear are oriented opposite to the teeth of the backward rack gear. When the pedal shaft is actuated forward, the forward rack gear moves forward so that the teeth of the forward rack gear come into contact with the female gear of the cover housing, thereby transmitting rotating force. When the pedal shaft is actuated backward, the forward rack gear moves backward to disengage from the female gear of the cover housing, and does not engage with the first female gear of the cover housing, since no teeth are provided in the backward direction. In the meantime, when the pedal shaft is actuated backward, the backward rack gear moves forward so that the teeth engage with the conversion gear group. When the pedal shaft is actuated forward, the backward rack gear moves backward to disengage from the conversion gear group. In addition, the forward rack gear and the backward rack gear are interconnected by a pin that extends through the rack gear-mounting member. The rack gear-mounting member has a pin hole that forms a gap with which the pin can move following the forward and backward movement of the rack gears.

In an embodiment of the invention, the conversion gear group includes a first gear and a second gear. Gear teeth of the first gear are formed in the inner and outer circumferences, and gear teeth of the second gear are engaged with the gear teeth in the outer circumference of the first gear to rotate in the opposite direction. The backward rack gear is configured to engage with the inner circumference of the first gear, and the second gear is configured to engage with the second female gear of the cover housing.

Here, the backward actuation is performed as follows: When the pedal shaft is rotated backward, the backward rack gear moves forward to transmit the backward rotation to the first gear, thereby rotating the first gear backward. The first gear rotates the second gear forward, which is engaged with the outer circumference of the first gear. Then, the gear teeth of the second gear are rotated by being engaged with the second female gear, which is formed in the inner circumference of the cover housing, thereby rotating the cover housing forward.

In the present invention, it is preferred that the second gear include a front gear, which is engaged with the first gear, and a rear gear, which is engaged with the second female gear.

In the present invention, a plurality of the second gears is provided at predetermined angles. It is preferred that three gears be arranged at intervals of 120° to transmit power.

In an aspect of the invention, a bicycle, which is propelled through forward and backward actuation, includes a pedal shaft, which is rotated forward or backward by pedals of the bicycle fixed thereto. Two shaft rotary members are fixed to the pedal shaft, and rotate following the rotation of the pedal shaft. A rack gear-mounting member is mounted on the shaft rotary members, in which two groups of rack gears, which convert the rotation of the pedal shaft into a linear movement, are supposed to be mounted on the rack gear-mounting member. A forward rack gear is provided on one side of the rack gear-mounting member and is engaged with one of the shaft rotary members. The forward rack year linearly moves to engage with a cover housing, thereby rotating the cover housing forward, when the pedal shaft is actuated forward, and moves backward to disengage from the cover housing when the pedal shaft is actuated backward. A backward rack gear is provided on the other side of the rack gear-mounting member and engaged with the other one of the shaft rotary members. The backward rack gear linearly moves to engage with a conversion gear group, which is engaged with the cover housing, thereby rotating the cover housing forward, when the pedal shaft is actuated backward, and moves backward to disengage from the conversion gear group when the pedal shaft is actuated forward. The cover housing is rotated by being engaged with the first rack gear and the conversion gear group, and a chain is connected to an outer circumference of the cover housing.

In the present invention, although the rotation of the pedal shaft of the bicycle transmits power to the cover housing so that the cover housing is rotated forward irrespective of the direction, the rotation of the cover housing does not transmit power to the pedals. When the cover housing rotates backward, the conversion gear group rotates, thereby causing the backward rack gear to disengage, and the disengaged rack gear does not move forward or backward any more unless the pedals are rotated.

### Advantageous Effects

As set forth above, the power transmission apparatus of the invention can be attached to any type of existing bicycle since it occupies a small space due to its simple structure, and eliminates the need to operate an additional conversion lever in order to propel the bicycle forward in the case of backward actuation.

In addition, the power transmission apparatus is free from small disorders and thus does not require regular maintenance. The power transmission apparatus is attractive when attached to a bicycle since it is slim, and has a simple design.

In addition, it is possible to double the exercise effect by using muscles that are not generally used at ordinary times, like walking backwards. Thereby, the fatigue of the leg muscles due to continued forward movement can be reduced.

In addition, it is easier to enjoy bicycle riding as a leisure activity.

Furthermore, the bicycle of the invention is configured such that the rotating force of the pedals is transmitted to the cover housing irrespective of the forward or backward direction but the rotation of the cover housing is not transmitted to the pedals. Accordingly, although a user gets off the bicycle and pulls it backward, the rotation of the cover housing does cause the pedal to rotate backward.

### DESCRIPTION OF DRAWINGS

FIG. 1 is an exploded perspective view showing a power transmission apparatus for a bicycle of the invention;

FIG. 2 is a cross-sectional view showing the power transmission apparatus for a bicycle of the invention;

FIG. 3 is a partially-exploded perspective view showing key parts of the power transmission apparatus for a bicycle of the invention;

FIG. 4 is a view showing the operation of the power transmission unit when the power transmission apparatus for a bicycle of the invention is actuated forward;

FIG. 5 is a view stowing the operation of the direction-converting unit when the power transmission apparatus for a bicycle of the invention is actuated backward;

FIG. 6 is an exploded perspective view explaining the role of the ball plunger of the power transmission apparatus for a bicycle of the invention;

FIG. 7 is a side-elevational view showing a rotary shaft having shaft rotary members according to another exemplary embodiment of the invention;

FIG. 8 is a view showing a rack gear according to another exemplary embodiment of the invention; and

FIG. 9 is a detailed view showing the rack gear-mounting member.

### BEST MODE

The present invention will now be described more fully hereinafter with reference to the accompanying drawings, in which exemplary embodiments thereof are shown.

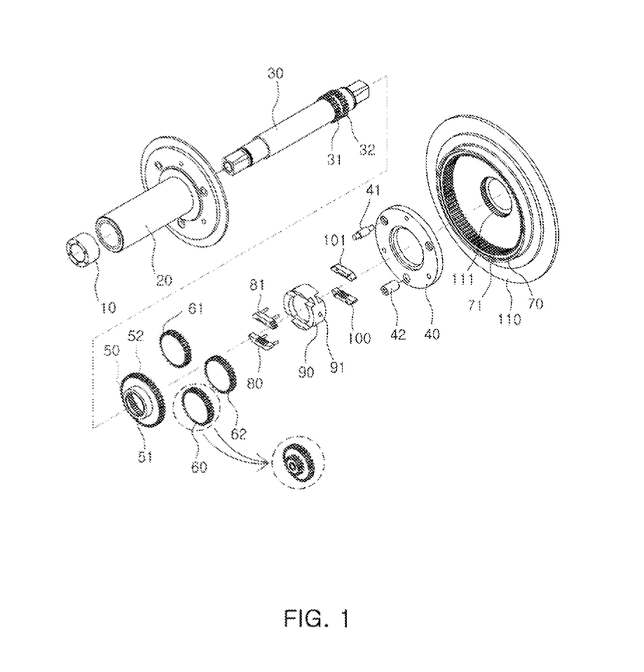

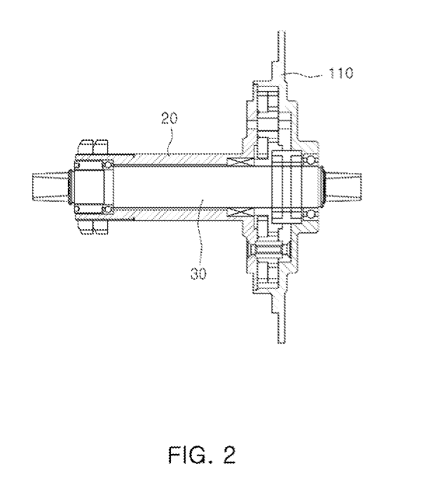

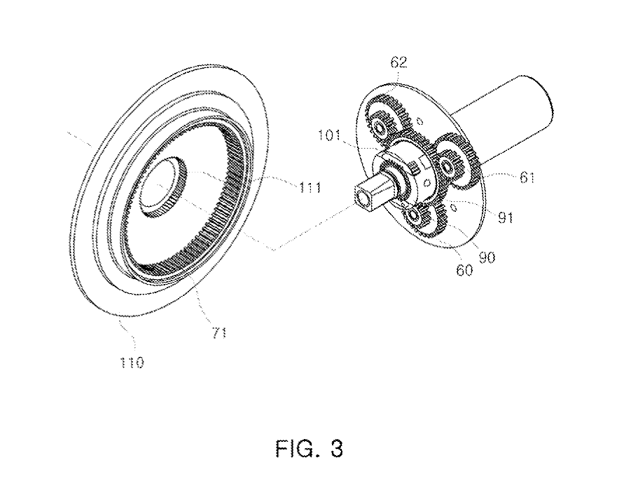

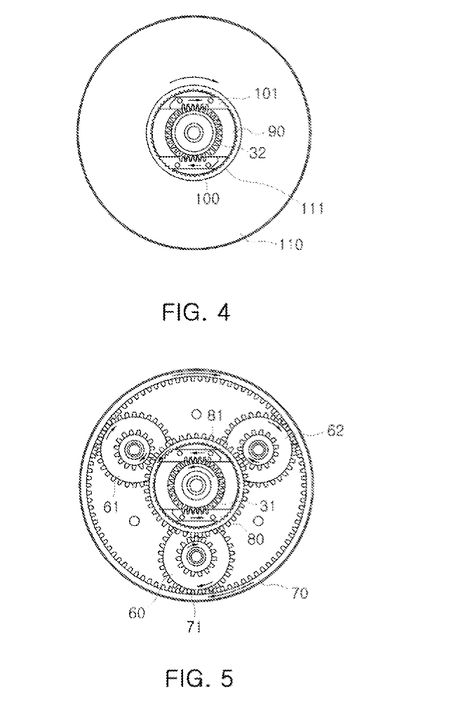

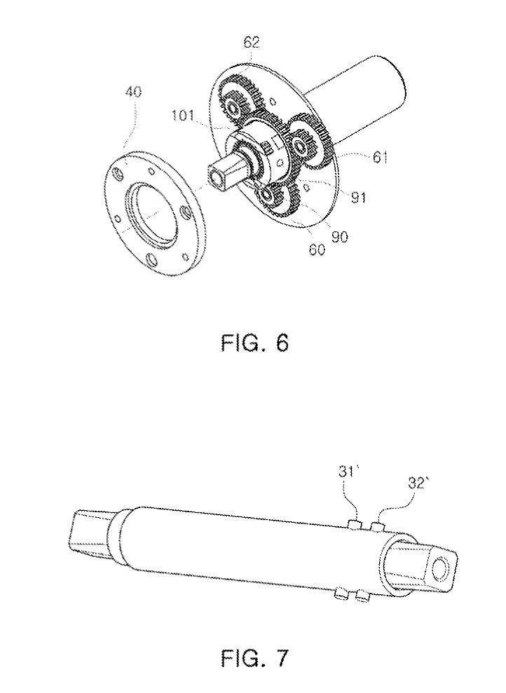

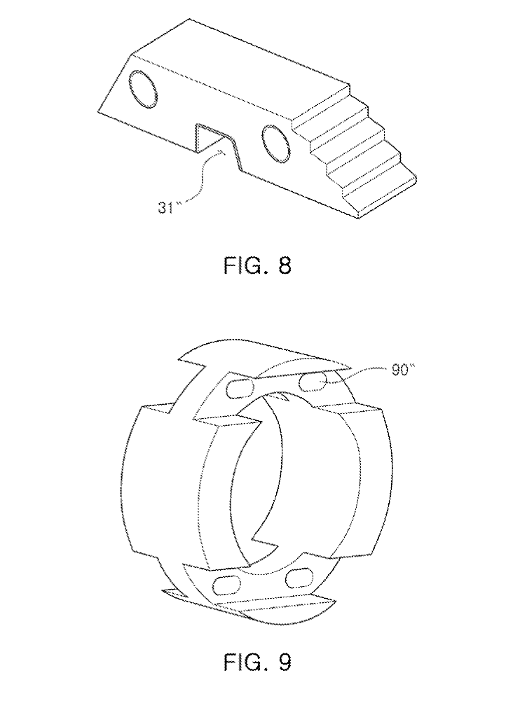

FIG. 1 is an exploded perspective view showing a power transmission apparatus for a bicycle of the invention, FIG. 2 is a cross-sectional view showing the power transmission apparatus for a bicycle of the invention, FIG. 3 is a partially-exploded perspective view showing key parts of the power transmission apparatus for a bicycle of the invention, FIG. 4 is a view showing the operation of the power transmission unit when the power transmission apparatus for a bicycle of the invention is actuated forward, FIG. 5 is a view showing the operation of the direction-converting unit when the power transmission apparatus for a bicycle of the invention is actuated backward, FIG. 6 is an exploded perspective view explaining the role of the ball plunger of the power transmission apparatus for a bicycle of the invention, FIG. 7 is a side-elevational view showing a rotary shaft having shaft rotary members according to another exemplary embodiment of the invention, FIG. 8 is a view showing a rack gear according to another exemplary embodiment of the invention, and FIG. 9 is a detailed view showing the rack gear-mounting member.

A power transmission apparatus for a bicycle of the invention generally includes a pedal shaft 30, two shaft gears 31 and 32, a rack gear-mounting member 90, a power transmission unit, a direction-converting unit, a shaft housing 20, and fastening members 41 and 42. The pedal shaft 30 is rotated forward or backward by the pedals of the bicycle, which are fixed thereto. The shaft gears 31 and 32 are fixed to the pedal shaft 30, and rotate following the rotation of the pedal shaft 30. The rack gear-mounting member 90 is mounted on the two shaft gears 31 and 32, and aids in the installation of two groups of rack gears, which convert the rotation of the pedal shaft 30 into a linear movement. The power transmission unit serves to transmit forward actuation of the pedal shaft 30 to a wheel. The direction-converting unit serves to transmit the backward actuation of the pedal shaft to the wheel by converting the backward actuation to a forward direction. The shaft housing 20 encases the foregoing components. The fastening members 41 and 42 fasten the foregoing components together.

The power transmission unit includes forward rack gears 100 and 101 and a cover housing 110. The forward rack gears 100 and 101 are provided on one side of the rack gear-mounting member 90, and have teeth in one side thereof. The teeth are engaged with the shaft gear 32 of the above-described two shaft gears in order to transmit the actuation of the pedal shaft 30 to the wheel. The cover housing 110 has a first female gear 111 in the inner circumference thereof, and is rotated by the contact of the first female gear 111 with the teeth of the forward rack gears 100 and 101.

In addition, the direction-converting unit includes backward rack gears 80 and 81, a first gear 50, second gears 60, 61, and 62, and a second female gear 70. The backward rack gears 80 and 81 are installed on the other side of the rack gear-mounting member 90, and have teeth in one side, so that the teeth are engaged with the shaft gear 31 of the above-described two shaft gears in order to transmit the actuation of the pedal shaft 30 to the wheel. The first gear 50 has a female gear 51 in the inner circumference thereof, and is rotated by the contact of the female gear 51 with the teeth of the backward rack gears 80 and 81. The first gear 50 also has gear teeth 52 on the outer circumference thereof. The second gears 60, 61, and 62 have gear teeth, and rotate through the engagement of the gear teeth with the gear teeth 52 on the outer circumference of the first gear 50. The second female gear 70 is formed in the cover housing 110, and has gear teeth 71 in the inner circumference thereof, which engage with the gear teeth of the second gears 60, 61, and 62.

The rack gear-mounting member 90 is shaped to form an opening into which the shaft gears 31 and 32 can be fitted. Forward rack gears are provided on one side of the rack gear-mounting member 90, and backward rack gears are provided on the other side of the rack gear-mounting member 90. It is preferred that a pair of the forward rack gears 100 and 101 be provided on the upper portion and a pair of the backward rack gears 80 and 81 be provided on the lower portion of the rack gear-mounting member 90.

When a pair of the forward rack gears 100 and 101 and a pair of the backward rack gears 80 and 81 are provided on the upper and lower portions as described above, power transmission can be stably carried out by the rack gears.

In addition, each of the forward rack gears 100 and 101 and the backward rack gears 80 and 81 is configured such that teeth are formed only on one side.

That is, each of the forward rack gears 100 and 101 and the backward rack gears 80 and 81 has a gear-like recess formed in the lower side thereof, which is intended to engage with the shaft gear 31 or 32, and teeth formed on one longitudinal end thereof. However, no teeth are formed on the longitudinal other end of the rack gear.

If rotating force is provided to one side of the rack gear on which the teeth are formed, the rack gear engages with a gear, which comes into contact therewith, thereby transmitting power to the engaged gear. If rotating force is provided to the other side on which no teeth are formed, the rack gear does not transmit power and is not actuated.

The forward rack gears 100 and 101 and the backward rack gears 80 and 81 are mounted on the rack gear-mounting member 90 such that the teeth of the forward rack gears are oriented opposite to the teeth of the backward rack gears.

That is, when the pedal shaft 30 is actuated forward, the teeth of the forward rack gears 100 and 101 come into contact with the female gear 111 of the cover housing 100, thereby transmitting rotating force, but the backward rack gears 80 and 81 are not actuated since they are in contact with the side surface, in which no teeth are formed.

In contrast, when the pedal shaft 30 is actuated backward, the teeth of the backward rack gear 80 and 81 come into contact with the female gear 51 of the first gear 50, thereby transmitting rotating force, but the forward rack gears 100 and 101 are not actuated and do not transmit rotating force since they come into contact with the side, in which no teeth are formed.

In the meantime, it is preferred that the second gears 60, 61, and 62 have a structure for transmitting rotating force. This structure includes a front gear, which is engaged with the first gear 50, and a rear gear, which is engaged with the second female gear 70.

In addition, as shown in the figures, the multiple second gears 60, 61, and 62 are provided at predetermined angles. In this embodiment of the invention, three gears are arranged at intervals of 120°, so that power can be stably transmitted thereby.

In addition, as shown in FIG. 1, a ball plunger 90 is formed on a side surface of the rack gear-mounting member 90. The ball plunger 90 generates a certain amount of frictional force between the rack gear-mounting member 90 and a coupling member 40, which couples the cover housing 110 with the shaft housing 20, in order to prevent the coupling member 40 from rotating in the state in which the rack gear is not moved forward or backward when the shaft gear 31 is rotated.

In other embodiments illustrated in FIGS. 7 and 8, shaft rotary members are shaft pins 31′ and 32′ protruding from the shaft. In the bottom of the rack gear, a recess 31′, which receives the shaft pins 31′ and 32′, can be provided in place of the gear teeth.

The reference numeral 10 in the figure, which has not been explained, indicates a snap ring, which is fitted into the pedal shaft 30.

Below, a description is given of a method of operating the power transmission apparatus for a bicycle of the invention, which has the above-described configuration.

First, in the case of forward actuation, as shown in FIG. 4, the pedal shaft 30 is actuated forward. Then, the forward rack gears 100 and 101, which are engaged with the shaft gear 32, linearly move in the clockwise direction (along the arrow in the figure), and rotate by being engaged with the first female gear 111 of the cover housing 110, thereby actuating the cover housing 110 forward.

Therefore, when the user rides on the bicycle, he/she can propel the bicycle forward by pushing the pedals forward.

At this time, the backward rack gears 80 and 81 do not transmit power, since they are not actuated, and the bicycle can only be propelled forward.

In addition, in the case of backward actuation, as shown in FIG. 5, the pedal shaft 30 is actuated backward. Then, the backward rack gears 80 and 81, which are engaged with the shaft gear 31, transmit the backward rotation to the first gear 50, which in turn converts the backward rotation to a forward direction via the second gears 60, 61, and 62, which are engaged with the first gear 50.

The forward rotation of the second gears 60, 61, and 62, cause the second female gear 70, in which the gear teeth 71, which engage with the gear teeth of the second gears 60, 61, and 62, are formed in the inner circumference thereof, to rotate forward, thereby rotating the cover housing 110 forward. Thereby, the rotation of the pedal shaft can be converted to the opposite direction.

Here, the forward rack gears 100 and 101 do not transmit power, since they are not actuated, and the bicycle can only be propelled forward.

As described above, the present invention allows the bicycle to only be propelled forward irrespective of the forward actuation or the backward actuation using two pairs of the rack gears, which are engaged with the shaft gears 31 and 32.

In addition, when the cover housing 110 is rotated backward (in the counterclockwise direction), the second gears 60, 61, and 62, which are engaged with the second female gear 71, rotate backward (in the counterclockwise direction), the first gear 50, which is engaged with the second gears 60, 61, and 62, rotates forward (in the clockwise direction), and the second rack gears 80 and 81 disengage from the first gear, so that the pedal shaft 30 is not rotated.

1. A power transmission apparatus for a bicycle, comprising:
a pedal shaft, wherein the pedal shaft is rotated forward or backward by pedals of the bicycle fixed thereto;
two shaft rotary members fixed to the pedal shaft, wherein the shaft rotary members rotate following a rotation of the pedal shaft;
a rack gear-mounting member mounted on the shaft rotary members, wherein two groups of rack gears, which convert the rotation of the pedal shaft into a linear movement, are supposed to be mounted on the rack gear-mounting member;
a first rack gear provided on one side of the rack gear-mounting member and engaged with one of the shaft rotary members, wherein the first rack gear linearly moves to engage with a cover housing, thereby rotating the cover housing forward, when the pedal shaft is actuated forward, and moves backward to disengage from the cover housing when the pedal shaft is actuated backward;
a second rack gear provided on the other side of the rack gear-mounting member and engaged with the other one of the shaft rotary members, wherein the second rack gear linearly moves to engage with a conversion gear group, which is engaged with the cover housing, thereby rotating the cover housing forward, when the pedal shaft is actuated backward, and moves backward to disengage from the conversion gear group when the pedal shaft is actuated forward; and
wherein the cover housing is rotated by being engaged with the first rack gear and the conversion gear group, and a chain is connected to an outer circumference of the cover housing.

2. The power transmission apparatus according to claim 1, wherein the conversion gear group includes a first gear, which has gear teeth in inner and outer circumferences thereof, and a second gear, wherein gear teeth of the second gear engage with the gear teeth in the outer circumference of the first gear so that the second gear rotates in a direction opposite to the first gear, and wherein the second rack gear engages with the inner circumference of the first gear, and the second gear engages with the cover housing.

3. The power transmission apparatus according to claim 1, wherein each the shaft rotary member is a shaft pin or a shaft gear.

4. The power transmission apparatus according to claim 1, wherein the rack gear-mounting member has an opening into which the shaft gear is allowed to be fitted, and wherein a pair of the forward rack gears is provided on an upper portion of the rack gear-mounting member and a pair of the backward rack gears is provided on a lower portion of the rack gear-mounting member.

5. The power transmission apparatus according to claim 1, wherein the cover housing defines therein a first female gear, which is formed in an inner circumference thereof to engage with the first rack gear, and a second female gear, which engages with the conversion gear group.

6. The power transmission apparatus according to claim 1, wherein the rack gears have teeth only in forward direction, wherein the forward rack gear and the backward rack gear are mounted on the rack gear-mounting member such that the teeth of the forward rack gear are oriented opposite to the teeth of the backward rack gear, whereby only the teeth of the forward rack gear come into contact with the first female gear of the cover housing to transmit rotating force when the pedal shaft is actuated forward and only the teeth of the backward rack gear come into in contact with the first gear to transmit rotating force when the pedal shaft is actuated backward.

7. The power transmission apparatus according to claim 1, wherein the second gear has a front gear, which is engaged with the first gear, and a rear gear, which is engaged with a second female gear of the cover housing.

8. The power transmission apparatus according to claim 1, wherein the rack gear-mounting member has a ball plunger to control a rotation of the mounting member.

9. A bicycle, which is propelled through forward and backward actuation, comprising the power transmission apparatus as described in claim 1, which is attached to the bicycle.

10. The bicycle according to claim 9, wherein the pedals are not moved by backward rotation of a chain of the power transmission apparatus.

11. The power transmission apparatus according to claim 2, wherein each the shaft rotary members is a shaft pin or a shaft gear.

12. The power transmission apparatus according to claim 2, wherein the rack gear-mounting member has an opening into which the shaft gear is allowed to be fitted, and wherein a pair of the forward rack gears is provided on an upper portion of the rack gear-mounting member and a pair of the backward rack gears is provided on a lower portion of the rack gear mounting member.

13. The power transmission apparatus according to claim 2, wherein the cover housing defines therein a first female gear, which is formed in an inner circumference thereof to engage with the first rack gear, and a second female gear, which engages with the conversion gear group.

14. The power transmission apparatus according to claim 2, wherein the rack gears have teeth only in forward direction, wherein the forward rack gear and the backward rack gear are mounted on the rack gear-mounting member such that the teeth of the forward rack gear are oriented opposite to the teeth of the backward rack gear, whereby only the teeth of the forward rack gear come into contact with the first female gear of the cover housing to transmit rotating force when the pedal shaft is actuated forward and only the teeth of the backward rack gear come into in contact with the first gear to transmit rotating force when the pedal shaft is actuated backward.

15. The power transmission apparatus according to claim 2, wherein the second gear has a front gear, which is engaged with the first gear, and a rear gear, which is engaged with a second female gear of the cover housing.

16. The power transmission apparatus according to claim 2, wherein the rack gear-mounting member has a ball plunger to control a rotation of the mounting member.

17. A bicycle, which is propelled through forward and backward actuation, comprising the power transmission apparatus as described in claim 2, which is attached to the bicycle.

18. The bicycle according to claim 17, wherein the pedals are not moved by backward rotation of a chain of the power transmission apparatus.
